(19) United States
(12) Patent Application Publication
(10) Pub. No.: US 2024/0070245 A1
(43) Pub. Date: Feb. 29, 2024

(54) SYSTEMS AND METHODS FOR REAL-TIME USER VERIFICATION AND MODIFICATION OF A MULTIMEDIA STREAM

(71) Applicant: AnonyDoxx, LLC, Savannah, GA (US)

(72) Inventors: Jonah Burglin, Savannah, GA (US); Jordan Burglin, Phoenix, AZ (US); Jeffrey Mingledorff, Savannah, GA (US); Eric Roden, Charleston, SC (US)

(21) Appl. No.: 18/237,517

(22) Filed: Aug. 24, 2023

Related U.S. Application Data
(60) Provisional application No. 63/400,560, filed on Aug. 24, 2022.

(51) Int. Cl. G06F 21/32; G06T 11/20; G06V 40/16; G10L 21/003; H04N 5/265

(52) U.S. Cl. CPC G06F 21/32; G06T 11/206; G06V 40/172; G10L 21/003; H04N 5/265; G10L 2021/0135

(57) ABSTRACT

A system for real-time verification and modification of a multimedia stream, includes a processor and a memory. The memory includes instructions stored thereon, which, when executed by the processor, cause the system to: access a real-time multimedia stream including a real-time image and real-time speech of a user, determine a facial mapping of the user based on the real-time image of the user; authenticate an identity of the user based on the facial mapping of the user, in response to the authenticated identity of the user generate a mask of the user based on the facial mapping of the user, modify the real-time multimedia stream to display the mask on the user, determine feedback based on analyzing the real-time multimedia stream of the user, and display the feedback in real time. The feedback includes a feedback score or a visual representation of a quality of an engagement of the user.

### CROSS-REFERENCE TO RELATED APPLICATIONS AND CLAIM OF PRIORITY

This application claims the benefit of, and priority to, U.S. Provisional Patent Application No. 63/400,560, filed on Aug. 24, 2022, the entire contents of each are hereby incorporated herein by reference.

### TECHNICAL FIELD

The present disclosure relates generally to the field of multimedia stream communications. More specifically, an aspect of the present disclosure provides systems and methods for real-time user verification and modification of a multimedia stream that includes the user.

### BACKGROUND

During online interviews or other online interactions, a person's accent or looks may influence the outcome of the interaction (e.g., interview). On the other hand, during a video conference, if a user uses an avatar, it may not be possible to know if the user is who they say they are.

Accordingly, there is interest in improving multimedia steam communications.

### SUMMARY

The present disclosure relates generally to the field of multimedia steam communications. More specifically, an aspect of the present disclosure provides systems and methods for real-time user verification and modification of a multimedia stream that includes the user.

In accordance with aspects of this disclosure, a system for real-time verification and modification of a multimedia stream is presented. The system includes a processor and a memory. The memory includes instructions stored thereon, which, when executed by the processor, cause the system to: access a real-time multimedia stream of a user. The real-time multimedia stream includes a real-time image of the user and a real-time speech of the user. The instruction, when executed by the processor, further cause the system to determine a facial mapping of the user based on the real-time image of the user; authenticate an identity of the user based on the facial mapping of the user, in response to the authenticated identity of the user generate a mask of the user based on the facial mapping of the user, modify the real-time multimedia stream to display the mask on the user, determine feedback based on analyzing the real-time multimedia stream of the user, and display the feedback in real-time. The feedback includes a feedback score or a visual representation of a quality of an engagement of the user.

In an aspect of the present disclosure, the instructions, when executed by the processor, may further cause the system to generate a modified real-time speech of the user based on the real-time speech of the user. The modified real-time speech of the user may be different from the real-time speech of the user.

In another aspect of the present disclosure, the modified real-time speech may include a modified accent, emotion, demeanor, and/or inflection.

In yet another aspect of the present disclosure, the real-time image of the user may be modified by a pre-determined avatar selected by the user.

In a further aspect of the present disclosure, the instructions, when executed by the processor, may further cause the system to determine that the feedback score is below a threshold value and provide a visual warning that the feedback is below the threshold value.

In yet a further aspect of the present disclosure, the real-time multimedia stream of a user may include biometric data. Determining feedback may include providing biometric data as an input to a machine learning network and predicting the feedback by the machine learning network.

In an aspect of the present disclosure, the instructions, when executed by the processor, may further cause the system to display a review screen. The review screen includes a multimedia review and replay the multimedia stream.

In another aspect of the present disclosure, authenticating the identity of the user may be further based on a unique ID stored in a blockchain.

In yet another aspect of the present disclosure, the visual representation of the quality of an engagement of the user may include a circular graph and/or a bar chart.

In a further aspect of the present disclosure, the instructions, when executed by the processor, may further cause the system to generate a final report after completion of the real-time multimedia stream. The final report may include a scrollable timeline and feedback correlated to a time of the timeline.

In accordance with aspects of this disclosure, a computer-implemented method for real-time verification and modification of a multimedia stream includes: accessing a real-time multimedia stream of a user, the real-time multimedia stream including a real-time image of the user and a real-time speech of the user, determining a facial mapping of the user based on the real-time image of the user, authenticating an identity of the user based on the facial mapping of the user, generating a mask of the user based on the facial mapping of the user in response to the authenticated identity of the user, modifying the real-time multimedia stream to display the mask on the user, determining feedback based on analyzing the real-time multimedia stream, and displaying the feedback in real time.

In yet a further aspect of the present disclosure, the method may further include generating a modified real-time speech of the user based on the real-time speech of the user. The modified real-time speech of the user may be different from the real-time speech of the user.

In an aspect of the present disclosure, the modified real-time speech includes a modified accent, emotion, demeanor, and/or inflection.

In another aspect of the present disclosure, the real-time image of the user may be modified by a pre-determined avatar selected by the user.

In yet another aspect of the present disclosure, the method may further include determining that the feedback score is below a threshold value and providing a warning that the feedback is below the threshold value.

In a further aspect of the present disclosure, the real-time multimedia stream of a user may include biometric data. Determining feedback may include providing biometric data as an input to a machine learning network and predicting the feedback by the machine learning network.

In yet a further aspect of the present disclosure, authenticating the identity of the user may be further based on a unique ID stored in a blockchain.

In an aspect of the present disclosure, the feedback further includes a circular graph and/or a bar chart.

In another aspect of the present disclosure, the method may further include generating a final report after completion of the real-time multimedia stream. The final report may include a scrollable timeline and feedback correlated to a time of the timeline.

In accordance with aspects of this disclosure, a non-transitory computer-readable medium storing instructions which, when executed by a processor, cause the processor to perform a computer-implemented method for real-time verification and modification of a multimedia stream is presented. The method includes: accessing a real-time multimedia stream of a user, the real-time multimedia stream including a real-time image of the user and a real-time speech of the user, determining a facial mapping of the user based on the real-time image of the user, authenticating an identity of the user based on the facial mapping of the user, generating a mask of the user based on the facial mapping of the user in response to the authenticated identity of the user, modifying the real-time multimedia stream to display the mask on the user, determining feedback based on analyzing the real-time multimedia stream, and displaying the feedback in real time.

The details of one or more aspects of this disclosure are set forth in the accompanying drawings and the description below. Other aspects, features, and advantages will be apparent from the description, the drawings, and the claims that follow.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a diagram illustrating an exemplary multimedia conference in a system for real-time verification and modification of a multimedia stream, in accordance with aspects of the present disclosure;

FIG. 2 is a block diagram of a controller configured for use with the system of FIG. 1, in accordance with aspects of the disclosure;

FIG. 3 is a block diagram of a deep learning network with inputs and outputs of a deep learning neural network, in accordance with aspects of the present disclosure;

FIG. 4 is a flow diagram of a computer-implemented method for real-time verification and modification of a multimedia stream, in accordance with aspects of the present disclosure;

FIG. 5 is a diagram illustrating capturing a user image, in accordance with aspects of the present disclosure;

FIGS. 6 and 7 are diagrams illustrating determining a facial mapping of a user, in accordance with aspects of the present disclosure;

FIG. 8 is a diagram illustrating selecting a real-time voice modification, in accordance with aspects of the present disclosure;

FIG. 9 is a diagram illustrating selecting an avatar, in accordance with aspects of the present disclosure;

FIG. 10 is a diagram illustrating displaying a mask of the user, in accordance with aspects of the present disclosure;

FIG. 11 is a diagram illustrating a waiting room in the multimedia conference, in accordance with aspects of the present disclosure;

FIG. 12 is a diagram illustrating showing a prompt to join the multimedia conference, in accordance with aspects of the present disclosure;

FIG. 13 is a diagram illustrating an exemplary question for the user in the multimedia conference, in accordance with aspects of the present disclosure;

FIGS. 14-17 are diagrams illustrating a real-time analysis of biometric data of the user, in accordance with aspects of the present disclosure;

FIG. 18 is a diagram illustrating a multimedia review screen, in accordance with aspects of the present disclosure;

FIG. 19 is a diagram illustrating analyzing the captured real-time image and real-time speech of the user, in accordance with aspects of the present disclosure; and

FIGS. 20-22 are diagrams illustrating reports based on the captured real-time image and real-time speech of the user, in accordance with aspects of the present disclosure.

Further details and aspects of exemplary aspects of the disclosure are described in more detail below with reference to the appended figures. Any of the above aspects and aspects of this disclosure may be combined without departing from the scope of the disclosure.

### DETAILED DESCRIPTION

The present disclosure relates generally to the field of multimedia steam verification modification. More specifically, an aspect of the present disclosure provides systems and methods for real-time user verification and modification of a multimedia stream that includes the user.

Although this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the drawings, and specific language will be used to describe the same. It will nevertheless be understood that no limitation of the scope of this disclosure is thereby intended. Any alterations and further modifications of the inventive features illustrated herein, and any additional applications of the principles of this disclosure, as illustrated herein, which would occur to one skilled in the relevant art and having possession of this disclosure, are to be considered within the scope of this disclosure.

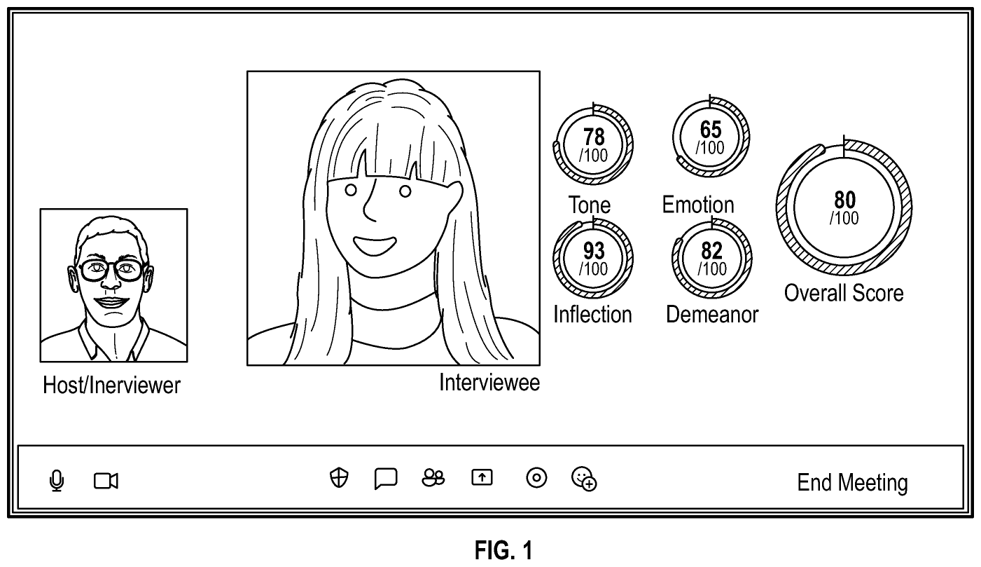

Referring to FIG. 1, an exemplary multimedia conference in a system for real-time user verification and modification of a multimedia stream that includes the user is shown. The disclosed technology enables real-time user verification and modification of a multimedia stream that includes the user. The disclosed systems and methods may be used, for example, for securely and verifiably modifying a multimedia stream, such as a video chat with an interviewee, so that the interviewer is not influenced by the looks or accent of the interviewee, such as during an interview for a job and/or for immigration proceedings. It is contemplated that the disclosed technology may be used for both interviewer and interviewee.

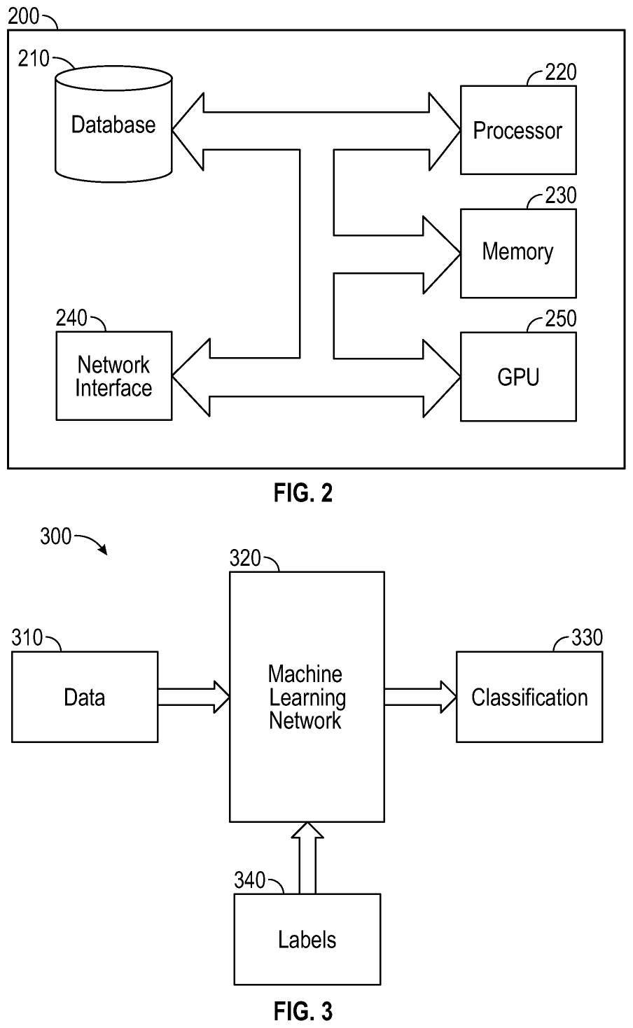

FIG. 2 illustrates controller 200 that includes a processor 220 connected to a computer-readable storage medium or a memory 230. The controller 200 may be used to control and/or execute operations of the system 100. The computer-readable storage medium or memory 230 may be a volatile type of memory, e.g., RAM, or a non-volatile type of memory, e.g., flash media, disk media, etc. In various aspects of the disclosure, the processor 220 may be another type of processor, such as a digital signal processor, a microprocessor, an ASIC, a graphics processing unit (GPU), a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the disclosure, the memory 230 can be random access memory, read-only memory, magnetic disk memory, solid-state memory, optical disc memory, and/or another type of memory. In some aspects of the disclosure, the memory 230 can be separate from the controller 200 and can communicate with the processor 220 through communication buses of a circuit board and/or through communication cables such as serial ATA cables or other types of cables. The memory 230 includes computer-readable instructions that are executable by the processor 220 to operate the controller 200. In other aspects of the disclosure, the controller 200 may include a network interface 240 to communicate with other computers or to a server. A storage device 210 may be used for storing data. The disclosed method may run on the controller 200 or on a user device, including, for example, on a mobile device, an IoT device, or a server system.

With reference to FIG. 3, a block diagram for a deep learning network 320 for classifying data in accordance with some aspects of the disclosure is shown. In some systems, a deep learning network 320 may include, for example, a convolutional neural network (CNN) and/or a recurrent neural network. A deep learning neural network includes multiple hidden layers. As explained in more detail below, the deep learning network 320 may leverage one or more classification models (e.g., CNNs, decision trees, Naive Bayes, k-nearest neighbor) to classify data. The deep learning network 320 may be executed on the controller 200 (FIG. 2). Persons skilled in the art will understand the deep learning network 320 and how to implement it.

In machine learning, a CNN is a class of artificial neural network (ANN), most commonly applied to analyzing visual imagery. The convolutional aspect of a CNN relates to applying matrix processing operations to localized portions of an image, and the results of those operations (which can involve dozens of different parallel and serial calculations) are sets of many features that are delivered to the next layer. A CNN typically includes convolution layers, activation function layers, deconvolution layers (e.g., in segmentation networks), and/or pooling (typically max pooling) layers to reduce dimensionality without losing too many features. Additional information may be included in the operations that generate these features. Providing unique information that yields features that give the neural networks information can be used to provide an aggregate way to differentiate between different data input to the neural networks. The deep learning network may include a convolutional long short-term memory neural network (CNN-LSTM). Although CNNs are used as an example, other machine learning classifiers are contemplated.

The deep learning network 320 may be trained based on labeling training data to optimize weights. For example, image feature data may be taken and labeled using other image feature data. In some methods in accordance with this disclosure, the training may include supervised learning or semi-supervised. Persons skilled in the art will understand training the deep learning network 320 and how to implement it.

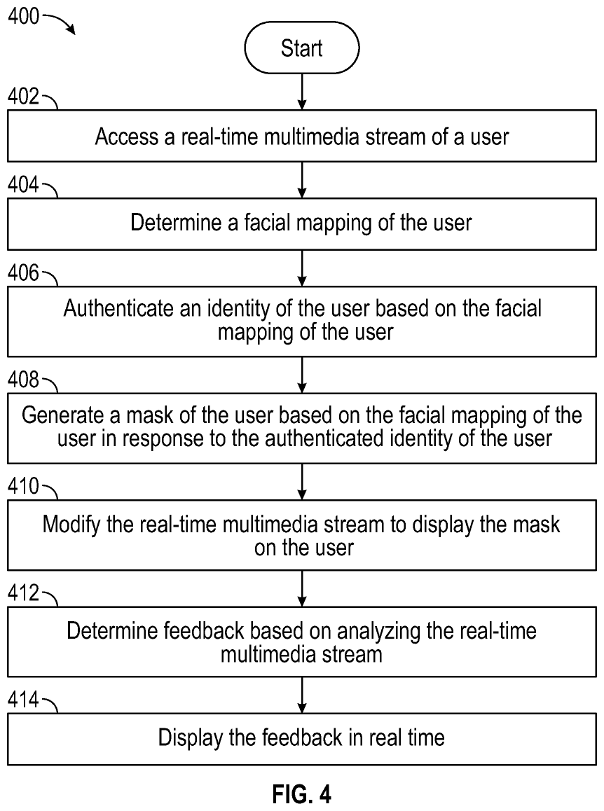

Referring to FIG. 4, a flow diagram for a method 400 in accordance with the present disclosure for real-time verification and modification of a multimedia stream that includes the user is shown. Although the blocks of FIG. 4 are shown in a particular order, the blocks need not all be performed in the illustrated order, and certain blocks can be performed in another order. For example, FIG. 4 will be described below, with a controller 200 of FIG. 2 performing the operations. In aspects, the operations of FIG. 4 may be performed all or in part by another device, for example, a server, a user device, and/or a computer system. These variations are contemplated to be within the scope of the present disclosure.

Initially, at block 402, the controller 200 accesses a real-time multimedia stream that includes a user. The real-time multimedia stream may include a real-time image of the user and/or a real-time speech of the user. The multimedia stream of the user may include biometric data on the user derived from the image of the user or the voice/speech of the user. The real-time multimedia stream may be captured using a webcam, for example, during a video conference.

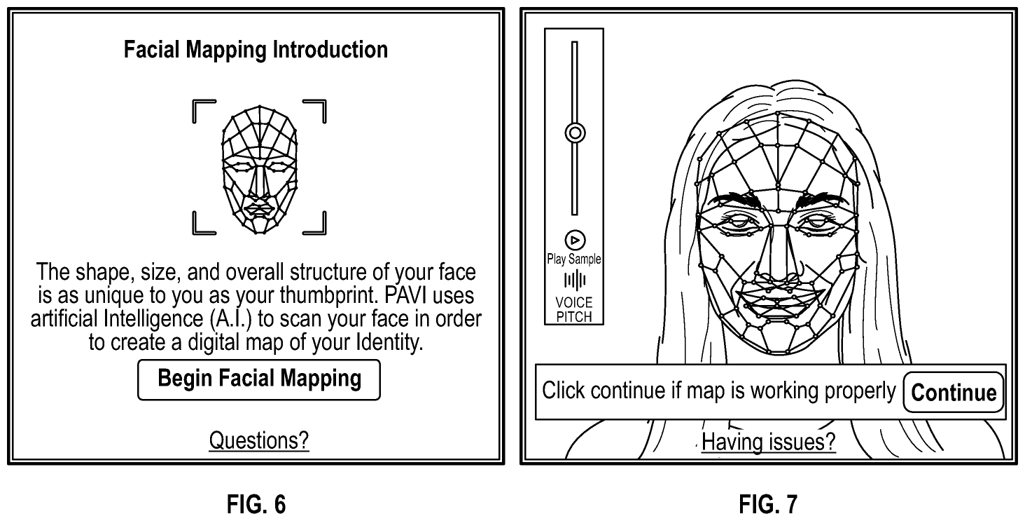

At block 404, the controller 200 determines a facial mapping of the user based on the real-time image of the user (FIGS. 6 and 7). Persons skilled in the art will understand how to implement the processing of block 404.

At block 406, the controller 200 authenticates an identity of the user based on the facial mapping of the user. In aspects, authenticating the identity of the user may further be based on a unique ID stored in a blockchain. For example, the blockchain may include an Ethereum-based blockchain. In aspects, the blockchain-based proof of identity provides users mobility and security. For example, the blockchain-based proof of identity provides a tamper-proof and trusted medium to distribute the asymmetric verification and encryption keys of the identity holders (i.e., the user). The controller 200 may use the voice of the user to authenticate the identity of the user. The user may onboard prior to the video chat (e.g., multimedia stream) by entering basic user information, which may be reviewed by a 3r d party background provider for baseline information. A multi-point biometric still frame scan with liveness check may be performed. The user may provide their identification, such as a driver's license, with may be matched with the still frame scan. The photo match may be compared to a threshold value to confirm the user's identity. For example, anything above about 80% would pass, and anything below 80% may go to a manual review. The name and address form the identification may be compared to the information entered.

At block 408 the controller 200 generates a mask of the user based on the facial mapping of the user in response to the authenticated identity of the user. For example, the real-time image of the user may be modified by a pre-determined avatar (i.e., mask) selected by the user.

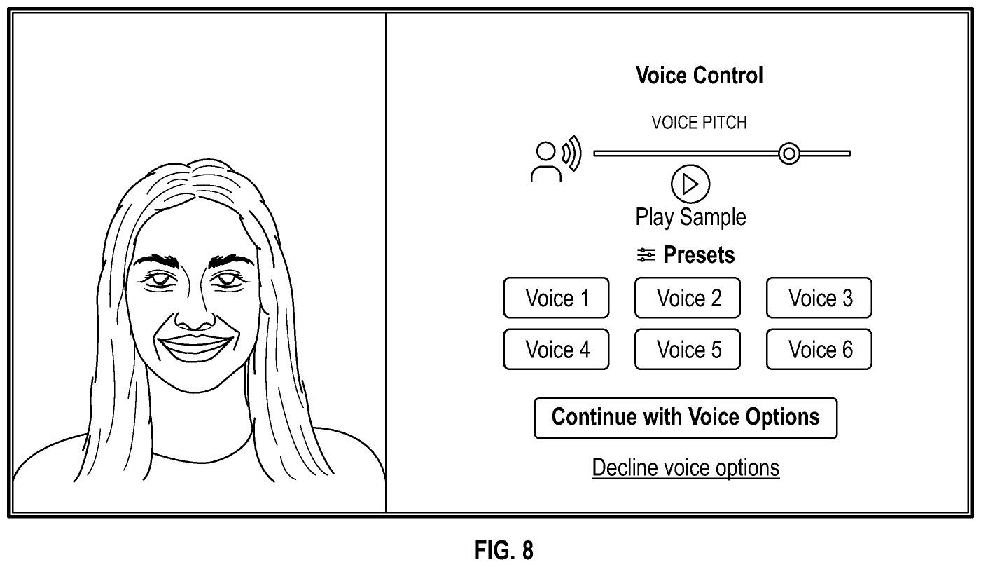

At block 410, the controller 200 modifies the real-time multimedia stream to display the predetermined avatar (e.g., mask) on the user in the multimedia stream. In aspects, the controller 200 may analyze the real time speech of the use and modify the real-time speech of the user based on the real-time speech of the user. The modified real-time speech of the user is different from the real-time speech of the user. For example, the modified real-time speech may include a modified accent, emotion, demeanor, and/or inflection (FIG. 8). The modified multimedia stream is communicated to a device of the other party, such as to the laptop of an interviewer.

At block 412, the controller 200 determines feedback based on analyzing the real-time multimedia stream. In aspects, the controller 200 may determine feedback by providing biometric data as an input to a machine learning network and predicting the feedback by the machine learning network.

At block 414, the controller 200 displays the feedback in real-time. The feedback may include a feedback score. In aspects, the controller 200 may determine that the feedback score is below a threshold value and provide a visual warning that the feedback is below the threshold value.

In aspects, the feedback may include a feedback score or a visual representation of a quality of an engagement of the user. The visual representation of the quality of an engagement of the user may include a circular graph and/or a bar chart.

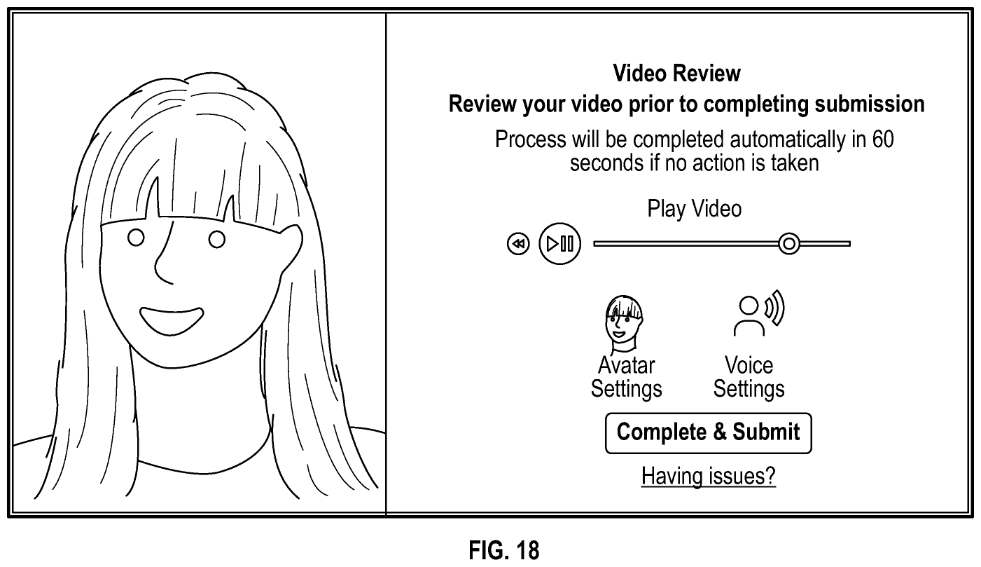

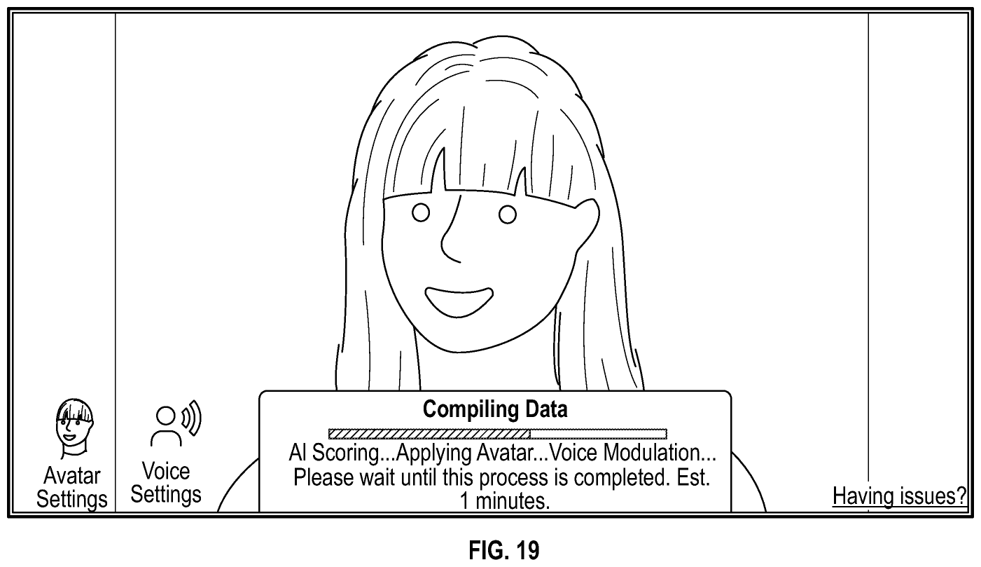

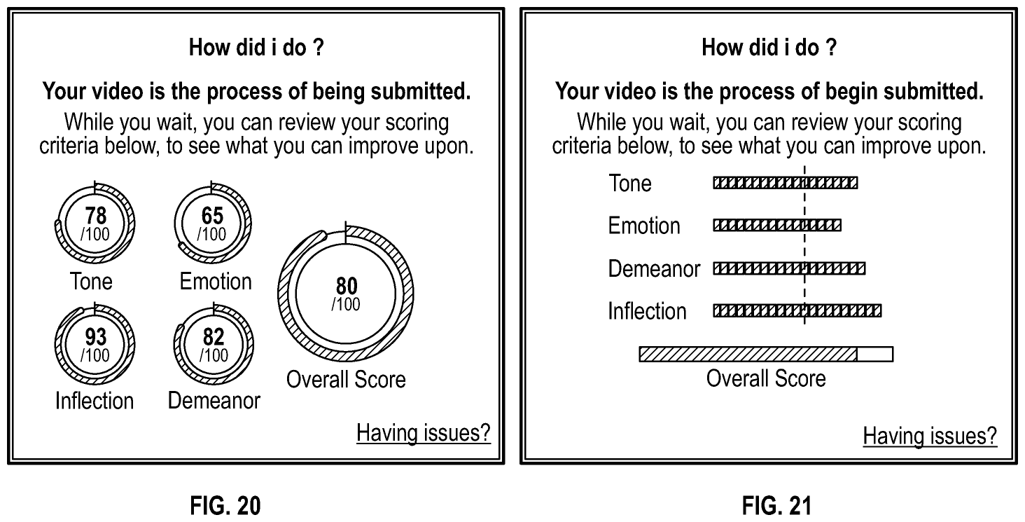

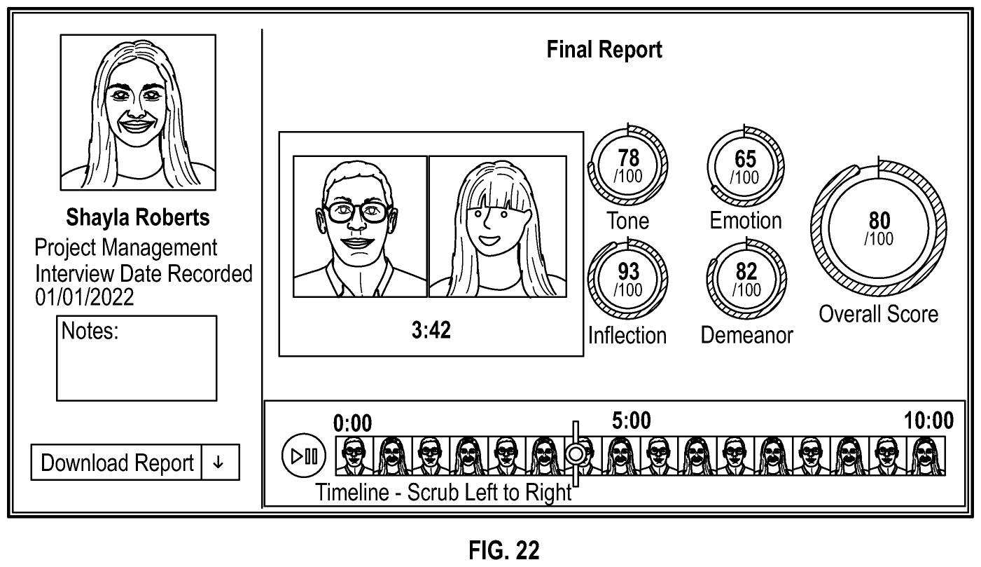

In aspects, the controller 200 may cause a display to display a review screen (FIG. 18). The review screen may include a multimedia review to enable the replay of the multimedia. For example, the controller 200 may generate a final report after completion of the real-time multimedia stream (FIGS. 19-21). In aspects, the final report may include a scrollable timeline and feedback correlated to a time of the timeline (FIG. 22).

In aspects, the method 400 may be used to continue the persona (the avatar and modified real-time speech) in a remote work environment. The method 400 enables integration with virtual meeting software to help minimize workplace bias as well while ensuring that the employee is always the person in attendance and monitoring engagement in real time. Monitoring engagement is valuable to provide progressive upward feedback internally and enable multi-layered companies to cater their messaging more effectively.

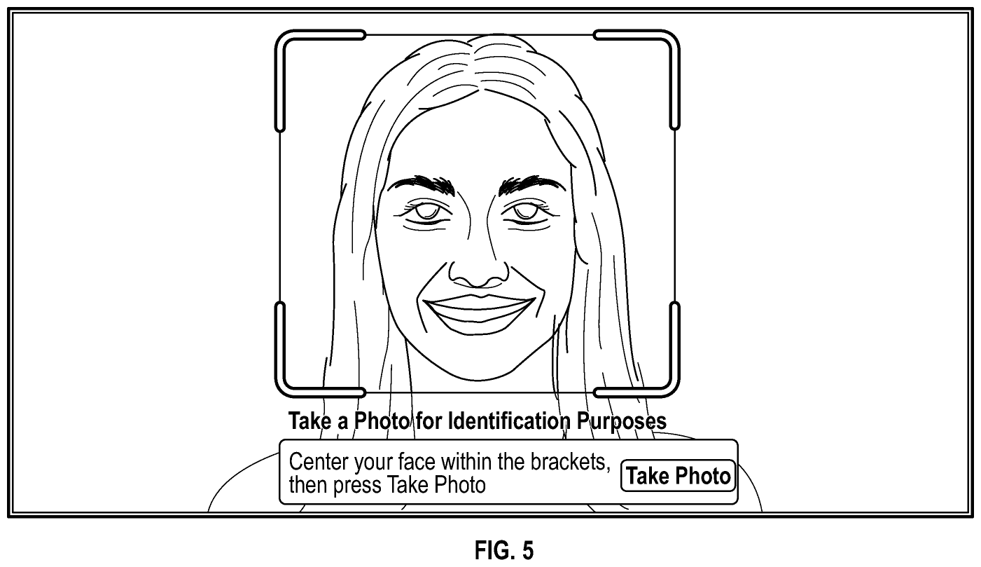

FIG. 5 is a diagram illustrating capturing a user image, for example, for use in block 402 of FIG. 4.

Referring to FIGS. 6 and 7, diagrams illustrating determining a facial mapping of a user are shown. Facial mapping is a method of biometric identification that uses that body measures, in this case, face and/or head, to enable verifying the identity of a person through its facial biometric pattern and data. The technology collects a set of unique biometric data of each person associated with their face and facial expression to identify, verify, and/or authenticate a person.

FIG. 8 is a diagram illustrating selecting a real-time modification of the voice and/or speech of the user. For example, the pitch of the user's voice may be modified. In aspects, the user may select among one of a number of voice presets, for example, a male voice or a female voice.

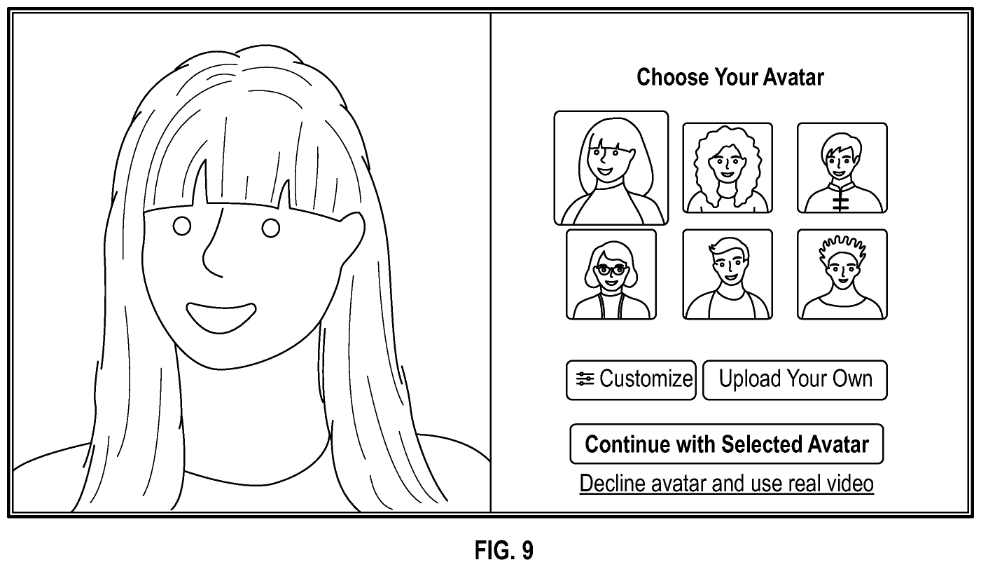

Referring to FIG. 9, a user may select an avatar amongst a set of possible avatars. The system may include options for customizing the avatar that the user selected. The user may upload their own avatar.

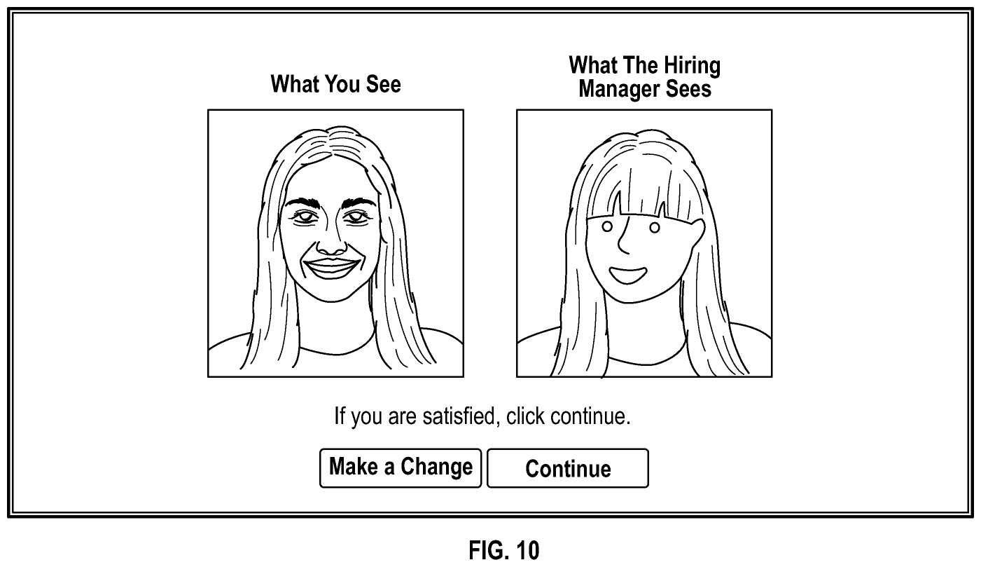

FIG. 10 is a diagram illustrating displaying a mask of the user. The User may be shown a screen of what the selected avatar looks like when used as a mask. The user may confirm the use of the avatar, or make a change.

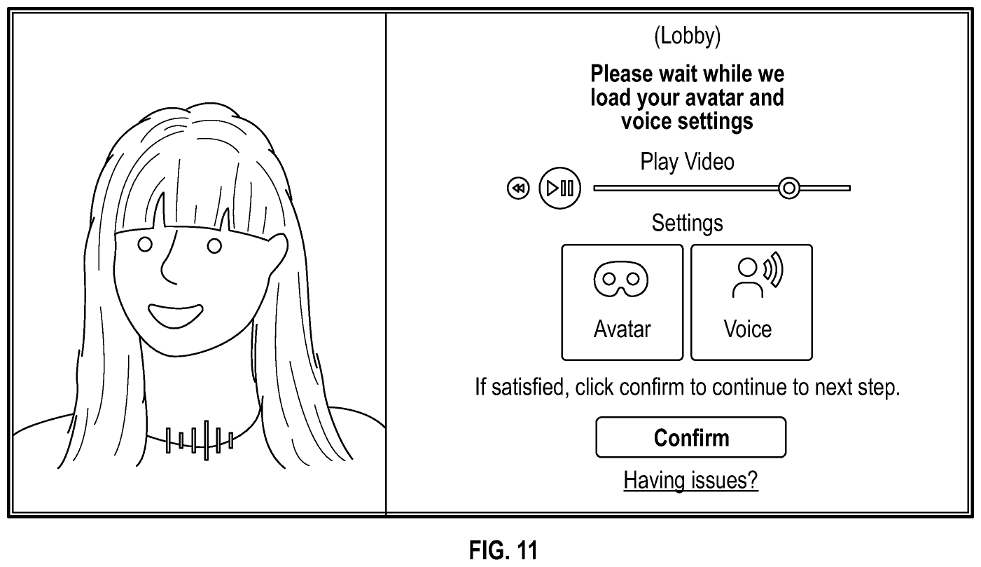

Referring to FIG. 11 a waiting room in the multimedia conference is shown. The waiting room may include options for changing the avatar (mask) and/or voice.

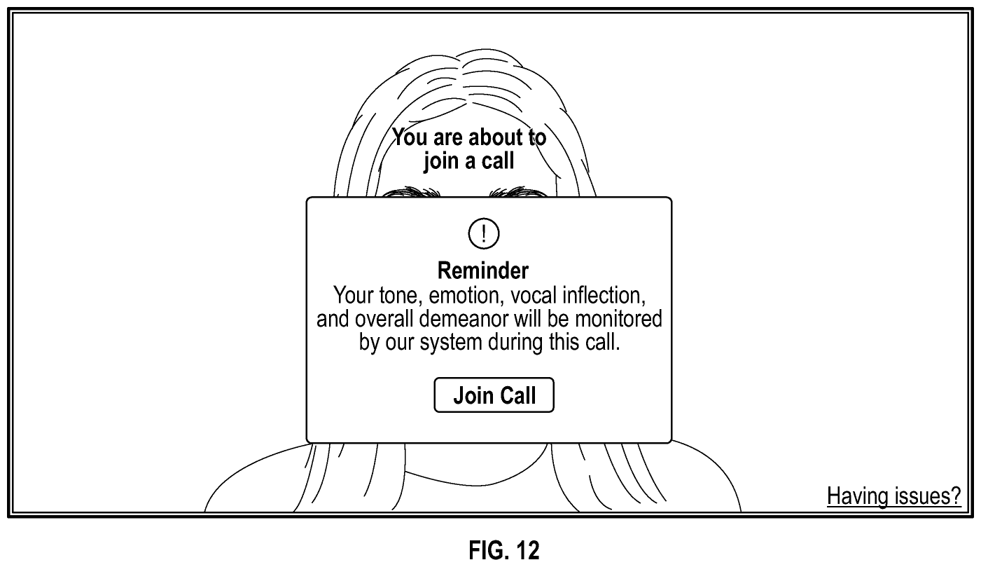

FIG. 12 is a diagram illustrating showing a prompt to join the multimedia conference. The prompt may provide a reminder that the user's tone, emotion, vocal inflection, and overall demeanor is being monitored by the system during the call.

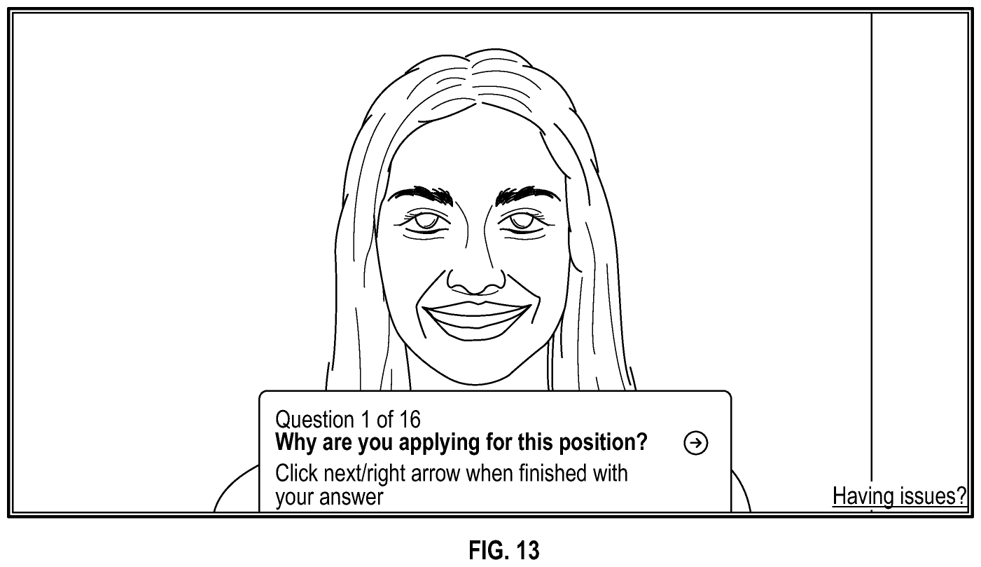

In aspects, the system may provide the user questions to answer during the multimedia conference (FIG. 13). For example, the questions may include “why are you applying for this position?”

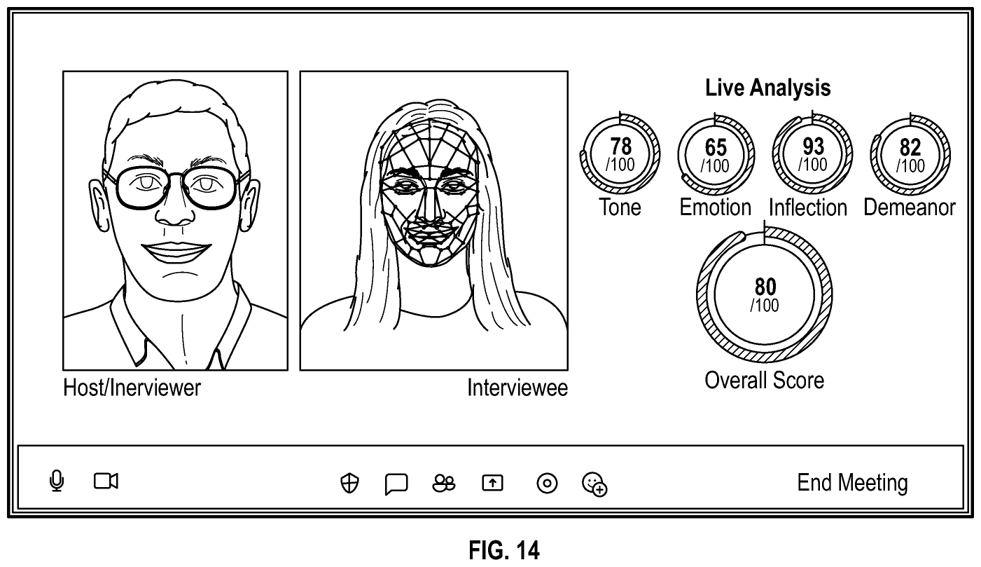

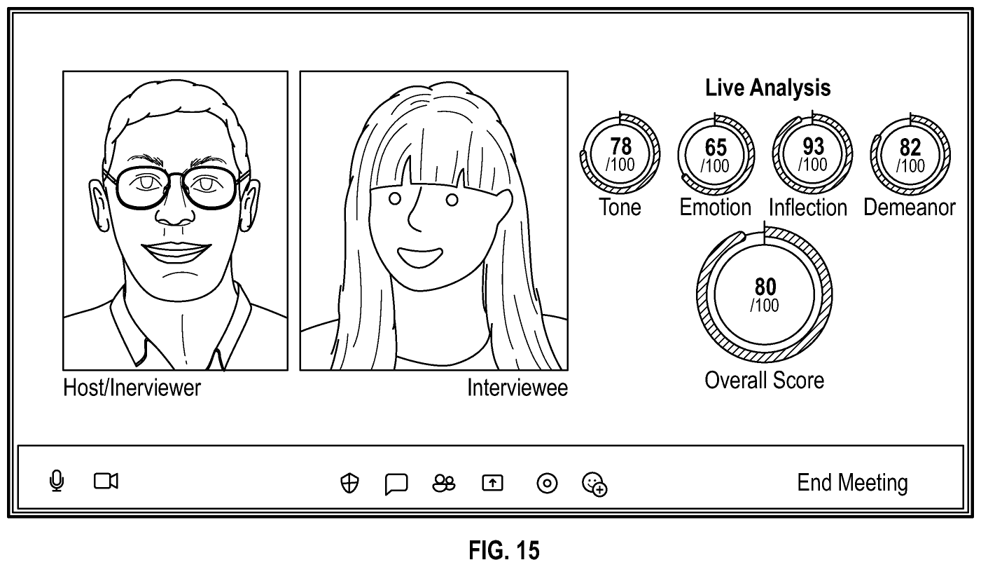

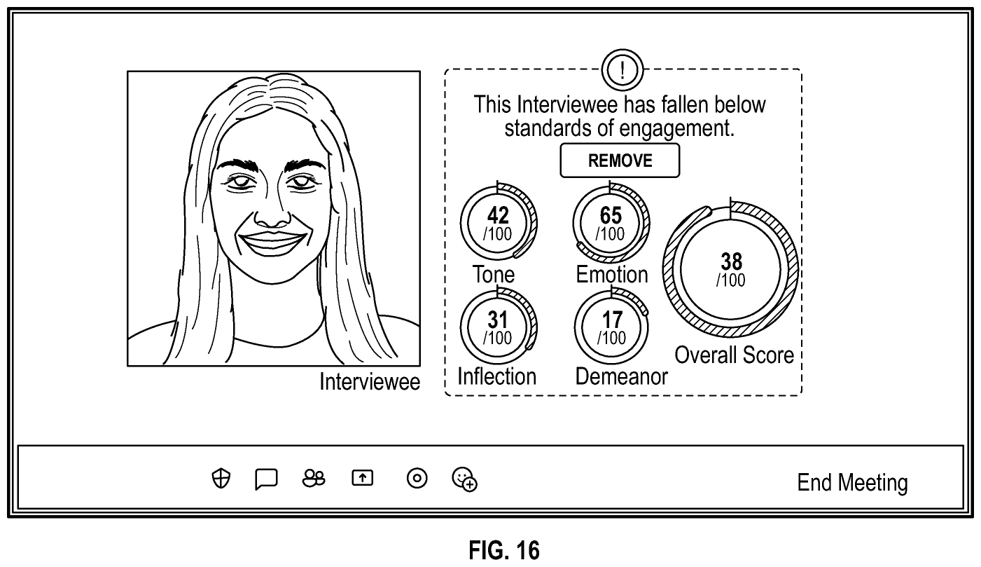

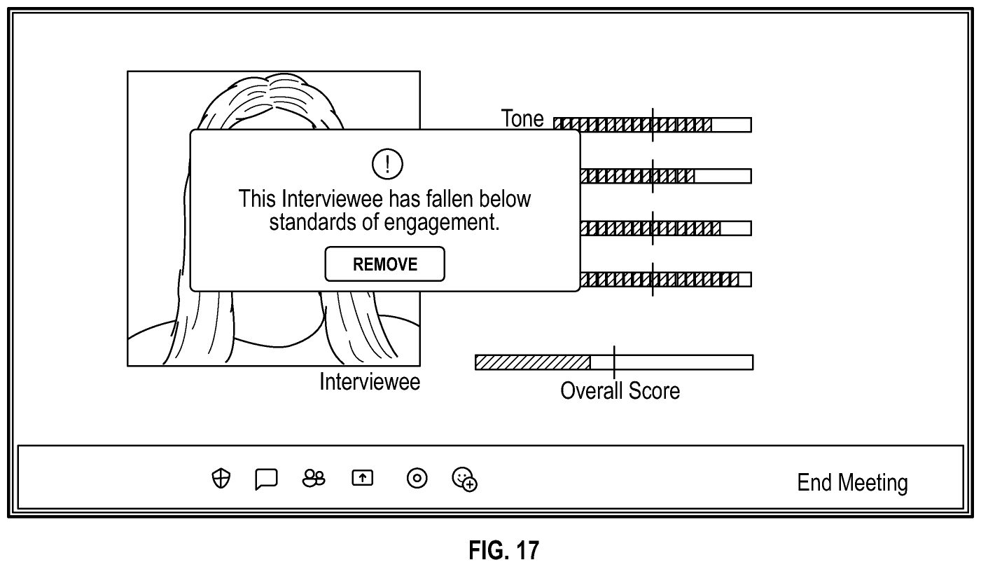

FIGS. 14-17 illustrate real-time analysis of biometric data of the user. The analysis of the biometric data may be used during blocks 410 and 412 described above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ this disclosure in virtually any appropriately detailed structure.

The phrases “in an aspect,” “in aspects,” “in various aspects,” “in some aspects,” or “in other aspects” may each refer to one or more of the same or different aspects in accordance with this disclosure.

It should be understood that the description herein is only illustrative of this disclosure. Various alternatives and modifications can be devised by those skilled in the art without departing from the disclosure. Accordingly, this disclosure is intended to embrace all such alternatives, modifications, and variances. The aspects described are presented only to demonstrate certain examples of the disclosure. Other elements, steps, methods, and techniques that are insubstantially different from those described above and/or in the appended claims are also intended to be within the scope of the disclosure.

What is claimed is:

1. A system for real-time verification and modification of a multimedia stream, comprising:
a processor; and
a memory, including instructions stored thereon, which, when executed by the processor, cause the system to:
access a real-time multimedia stream that includes a user, wherein the real-time multimedia stream includes a real-time image of the user and real-time speech of the user;
determine a facial mapping of the user based on the real-time image of the user;
authenticate an identity of the user based on the facial mapping of the user;
in response to the authenticated identity of the user generate a mask of the user based on the facial mapping of the user;
modify the real-time multimedia stream to display the mask on the user;
determine feedback based on analyzing the real-time multimedia stream of the user, wherein the feedback includes a feedback score or a visual representation of a quality of an engagement of the user; and
display the feedback in real time.

2. The system of claim 1, wherein the instructions, when executed by the processor, further cause the system to generate a modified real-time speech of the user based on the real-time speech of the user, wherein the modified real-time speech of the user is different from the real-time speech of the user.

3. The system of claim 2, wherein the modified real-time speech includes a modified accent, emotion, demeanor, and/or inflection.

4. The system of claim 1, wherein the real-time image of the user is modified by a pre-determined avatar selected by the user.

5. The system of claim 1, wherein the instructions, when executed by the processor, further cause the system to:
determine that the feedback score is below a threshold value; and
provide a visual warning that the feedback is below the threshold value.

6. The system of claim 1, wherein the real-time multimedia stream of a user includes biometric data, wherein determining feedback includes:
providing biometric data as an input to a machine learning network; and
predicting the feedback by the machine learning network.

7. The system of claim 1, wherein the instructions, when executed by the processor, further cause the system to:
display a review screen, wherein the review screen includes a multimedia review; and
replay the multimedia stream.

8. The system of claim 1, wherein authenticating the identity of the user is further based on a unique ID stored in a blockchain.

9. The system of claim 1, wherein the visual representation of the quality of an engagement of the user includes a circular graph and/or a bar chart.

10. The system of claim 1, wherein the instructions, when executed by the processor, further cause the system to generate a final report after completion of the real-time multimedia stream, wherein the final report includes a scrollable timeline and feedback correlated to a time of the timeline.

11. A computer-implemented method for real-time verification and modification of a multimedia stream, the method comprising:
accessing a real-time multimedia stream that includes a user, the real-time multimedia stream including a real-time image of the user and a real-time speech of the user;
determining a facial mapping of the user based on the real-time image of the user;
authenticating an identity of the user based on the facial mapping of the user;
generating a mask of the user based on the facial mapping of the user in response to the authenticated identity of the user;
modifying the real-time multimedia stream to display the mask on the user;
determining feedback based on analyzing the real-time multimedia stream; and
displaying the feedback in real time.

12. The computer-implemented method of claim 11, further comprising generating a modified real-time speech of the user based on the real-time speech of the user, wherein the modified real-time speech of the user is different from the real-time speech of the user.

13. The computer-implemented method of claim 12, wherein the modified real-time speech includes a modified accent, emotion, demeanor, and/or inflection.

14. The computer-implemented method of claim 11, wherein the real-time image of the user is modified by a pre-determined avatar selected by the user.

15. The computer-implemented method of claim 11, wherein the feedback includes a feedback score, and wherein the method further comprises:
determining that the feedback score is below a threshold value; and
providing a warning that the feedback is below the threshold value.

16. The computer-implemented method of claim 11, wherein the real-time multimedia stream of a user includes biometric data, wherein determining feedback includes:
providing biometric data as an input to a machine learning network; and
predicting the feedback by the machine learning network.

17. The computer-implemented method of claim 11, wherein authenticating the identity of the user is further based on a unique ID stored in a blockchain.

18. The computer-implemented method of claim 11, wherein the feedback further includes a circular graph and/or a bar chart.

19. The computer-implemented method of claim 11, further comprising generating a final report after completion of the real-time multimedia stream, wherein the final report includes a scrollable timeline and feedback correlated to a time of the timeline.

20. A non-transitory computer-readable medium storing instructions which, when executed by a processor, cause the processor to perform a computer-implemented method for real-time verification and modification of a multimedia stream, comprising:
accessing a real-time multimedia stream that includes a user, the real-time multimedia stream including a real-time image of the user and a real-time speech of the user;
determining a facial mapping of the user based on the real-time image of the user;
authenticating an identity of the user based on the facial mapping of the user;
generating a mask of the user based on the facial mapping of the user in response to the authenticated identity of the user;
modifying the real-time multimedia stream to display the mask on the user;
determining feedback based on analyzing the real-time multimedia stream; and
displaying the feedback in real time.
